(19) United States
(12) Patent Application Publication
(10) Pub. No.: US 2018/0181746 A1
(43) Pub. Date: Jun. 28, 2018

(54) METHOD OF EXECUTING A SECURITY-RELEVANT APPLICATION, COMPUTER SYSTEM, AND ARRANGEMENT

(71) Applicant: Fujitsu Technology Solutions Intellectual Property GmbH, München (DE)

(72) Inventors: Jürgen Atzkern, München (DE); Thilo Cestonaro, München (DE); Diana Filimon, München (DE)

(21) Appl. No.: 15/577,100

(22) PCT Filed: May 25, 2016
(86) PCT No.: PCT/EP2016/061830

§ 371 Date: Nov. 27, 2017

(30) Foreign Application Priority Data
May 27, 2015 (DE) 10 2015 108 336.1

(51) Int. Cl. G06F 21/51; G06F 17/30; H04L 29/06; G06F 21/54

(52) U.S. Cl. CPC G06F 21/51; G06F 17/30123; G06F 2221/033; H04L 63/126; G06F 21/54; G06F 17/30109

(57) ABSTRACT

A method of executing a security-relevant application on a computer system in a secured environment includes establishing a data network connection via an internal network of the secured environment between the computer system and a server arranged in the secured environment; searching, by the computer system, for at least one predetermined file on the server after the data network connection has been established; verifying, by the computer system, a signature of the at least one predetermined file, if the at least one predetermined file has been found; executing, by the computer system, the at least one predetermined file if the verification of the signature was successful, wherein a system file is modified through the execution of the at least one predetermined file; and starting the security-relevant application after the at least one predetermined file has been successfully executed.

### TECHNICAL FIELD

This disclosure relates to a method of executing a security-relevant application on a computer system, a computer system with a data network interface, as well as an arrangement including a computer system and a server.

### BACKGROUND

Computer systems such as payment terminals to carry out financial transactions, for example, on which a user must authenticate themselves generally severely restrict access to system files.

There is a need to provide a method of executing a security-relevant application on a computer system and provide devices to carry out the method.

### SUMMARY

We provide a method of executing a security-relevant application on a computer system in a secured environment including establishing a data network connection via an internal network of the secured environment between the computer system and a server arranged in the secured environment; searching, by the computer system, for at least one predetermined file on the server after the data network connection has been established; verifying, by the computer system, a signature of the at least one predetermined file, if the at least one predetermined file has been found; executing, by the computer system, the at least one predetermined file if the verification of the signature was successful, wherein a system file is modified through the execution of the at least one predetermined file; and starting the security-relevant application after the at least one predetermined file has been successfully executed.

We also provide a computer system with a data network interface, wherein the computer system is configured to establish in a secured environment a data network connection to a server via an internal network via the data network interface, which server is arranged in the secured environment, and to search at least one predetermined file on the server after the data network connection has been established, and to verify a signature of the at least one predetermined file when the at least one predetermined file has been found on the server, and to execute the at least one predetermined file, and subsequently, to start a security-relevant application, wherein a system file is modified upon execution of the at least one predetermined file.

We further provide an arrangement including computer system and a server, wherein the server is arranged in a secured environment with an internal network, and provides at least one predetermined file for the computer system, wherein the computer system is configured to search for the at least one predetermined file on the server, and, after finding the at least one predetermined file, to verify a signature of the at least one predetermined file, and, after successful verification of the signature, to execute the at least one predetermined file and, subsequently, to start a security-relevant application.

### BRIEF DESCRIPTION OF THE DRAWINGS

FIG. 1 is a schematic illustration of an arrangement according to one example.

FIG. 2 is a flow chart of a method according to one example.

### LIST OF REFERENCE CHARACTERS

10 Secured environment
11 Server
12, 12′, 12″ Computer system
13 Data network interface
14 Predetermined file
15 Signature
20 Flow chart
21-27 Method steps

### DETAILED DESCRIPTION

We provide a method of executing a security-relevant application on a computer system in a secured environment. Here, a data network connection is established via an internal network of the secured environment between the computer system and a server, which is arranged in the secured environment. Subsequent thereto, at least one predetermined file is searched for on the server through the computer system. If the at least one predetermined file is found, then a signature of the at least one predetermined file is verified. If verification of the signature was successful, then the at least one predetermined file will be downloaded and executed, wherein a system file is modified through execution of the at least one predetermined file. The security-relevant application is started subsequent thereto.

Such devices must be able to be maintained upon occurrence of malfunctions. A service department or maintenance service must thereby also be able to gain access to security-relevant areas of the protected peripheral device. This must take place within a secure environment, not without authorization or accidentally. No unauthorized access to the server is possible due to a verification of a user certificate. The computer system establishes a data network connection with a server. For example, the computer system establishes the data network connection with an update server to search for automatic updates. Here, at least one predetermined file is searched for. Verification of the signature of the predetermined file serves the verification of the security of the file. If the file is authenticated, then it is downloaded and executed. A system file of the computer system is hereby modified. A security-relevant application, in particular a memory reflash, or rather a complete system reflash, can be carried out via the modification. Here, carrying out includes an installation of the at least one predetermined file, and a hereto subsequent call-up of the installed file through the file itself or a program.

Advantageously, the execution of the at least one predetermined file may include a renaming of the system file.

A specific file can be renamed or changed to carry out maintenance on the computer system. For example, a boot file, in particular a so-called boot-up file, is given a new name so that a system reflash is made possible.

Further advantageously, the at least one predetermined file may be part of a file package, and the file package may be searched for, verified, downloaded, and executed.

The file package can include various predetermined files through which various functions and maintenance algorithms can be carried out on the computer system.

Further advantageously, a memory of the computer system may be programmed upon execution of the security-relevant application.

Through the programming or the reprogramming of the flash memory, system settings of the computer system can be changed.

Still further advantageously, a recovery mode may be called up upon execution of the security-relevant application.

The computer system can, for example, be restored to its original factory settings via the calling up of the recovery mode.

We also provide a data network interface. Here, the computer system is configured to establish in a secured environment a data network connection to a server via an internal network, which server is arranged in the secured environment, and to search for at least one predetermined file on the server, after the data network connection has been established. The computer system is further configured to verify a signature of the at least one predetermined file if the at least one predetermined file has been found on the server. Moreover, the computer is configured to download and execute the at least one predetermined file and, subsequently, to start a security-relevant application. A system file is modified upon execution of the at least one predetermined file.

Here, the server can be an update server. Such a computer system can automatically search for configuration files during a search for updates and execute them. Here, if a predetermined file is trusted, then further security-relevant changes in the system can be carried out. Security of the server can be ensured through verification of a signature of the server, or via a Https-connection with a user certificate originating from the same authority as the signature of the server. Physical access to the server can also be secured via restriction of access to the server, for example, a secure area, and via a four-eye principle so that no person can physically work on the server alone.

We further provide an arrangement including a computer system and a server. Here, the server is arranged in a secured environment with an internal network. The server provides at least one predetermined file for the computer system. Here, the computer system is configured to search at least one predetermined file on the server and, after finding the at least one predetermined file, to verify a signature of the at least one predetermined file. Furthermore, the computer system is configured to download and execute the at least one predetermined file after a successful verification of the signature and, subsequently, to start a security-relevant application.

The server provides the predetermined file as an update file, for example. Due to the fact that the server is located in a secured environment, it is assumed that only trustworthy persons have access to the server. Thus, verification of the signature of the predetermined file is sufficient to further ensure security for the computer system. The secure area is a security zone in a company, for example. Access to the security zone can be protected by a four-eye principle.

Advantageously, the server and the computer system may be connected to an internal network of a maintenance center or service center.

If the secure area is a maintenance center or a service center, the computer system and the server can connect to the internal network of the maintenance center or service center. Here, the server cannot be accessed from outside the maintenance center or the service center. Thus, high security of the arrangement is ensured.

Advantageously, the security-relevant application may be configured to program a flash memory of the computer system.

Further advantageously, the security-relevant application is configured to call up a recovery mode.

A recovery mode is particularly suitable for the maintenance of a computer system. Here, defects, in particular defective software, can be repaired.

Our methods and systems are explained in further detail by examples and figures.

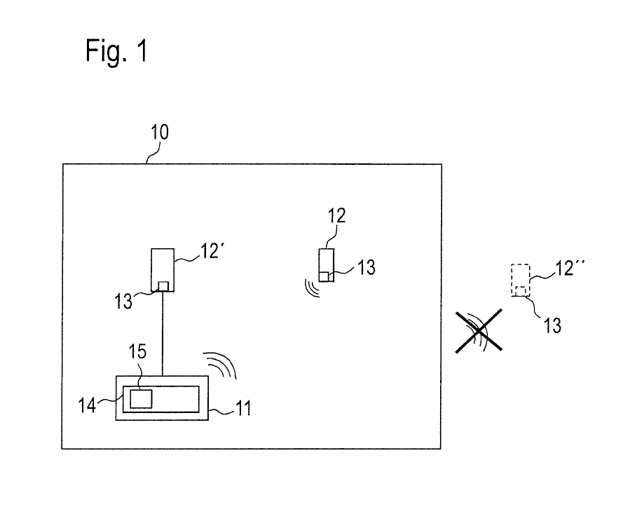

FIG. 1 shows a secured environment 10. The secured environment 10 is a maintenance center to maintain computer systems 12, 12′. In other configurations, the secured environment 10 can also be other secured environments such as locally restricted areas, e.g. a production plant or a service center.

For example, the secure environment 10 is a security zone in a company. Access to the security zone is protected by a four-eye principle so that no person can physically work on the server alone.

A server 11 is arranged in the secured environment 10. For example, the server 11 is located in a specially protected server room in the maintenance center to which only a selected group of people have access. Access to the server 11 is restricted, e.g. through an access authorization only for the selected group of people. The server 11 serves to provide service packages and maintenance software for a maintenance of the computer systems 12, 12′. In the example, a computer system 12″ is excluded from the secured environment. Staff members of the maintenance center or the secured environment can thus indirectly perform actions in computer systems 12, 12′. The location of the server 11 is protected by the secured environment 10. In addition, a cryptographic protection is provided for access to the server 11. For example, a user must enter a password to be able to open a server rack and work on the server 11.

In the example, the computer systems 12, 12′, 12″ are embedded computer systems in the form of payment terminals to carry out financial transactions of a user, e.g. on the checkout counter in supermarkets or department stores. A user uses the computer system 12, 12′, 12″ e.g. to authenticate personal data. In other configurations, the computer systems 12, 12′, 12″ are computer systems for the verification of access checks, automatic teller machines (ATMs), board computers of vehicles or generally computer systems storing and/or processing security-relevant data.

The computer systems 12, 12′, 12″ can establish a data network connection. To that end, they have a data network interface 13. The computer system 12 comprises a Wireless Local Area Network (WLAN) module as a data network interface 13. The computer system 12′ comprises a Local Area Network (LAN) port as a data network interface. In the schematic illustration of FIG. 1, the computer systems 12 and 12′ are located in the secured environment 10 and have access to an internal network of the secured environment 10. The computer system 12″ is not located in the secured environment 10 (dashed illustration). The computer system 12″ does not have access to the internal network and the server 11.

The computer systems 12 and 12′ connect to the server 11 via the internal network of the secured environment 10. The computer system 12 connects to the server 11 in a wireless manner through a WLAN, computer system 12′ is directly connected to the server 11 via a cable connection, in particular a LAN connection. In not-illustrated configurations, the computer systems 12 and 12′ indirectly connect to the server 11, e.g. through a router.

The internal network of the secured environment 10 is locally restricted to the secured environment 10. In the case of a WLAN connection, the WLAN strength is selected such that the WLAN cannot be accessed from outside the secured environment 10.

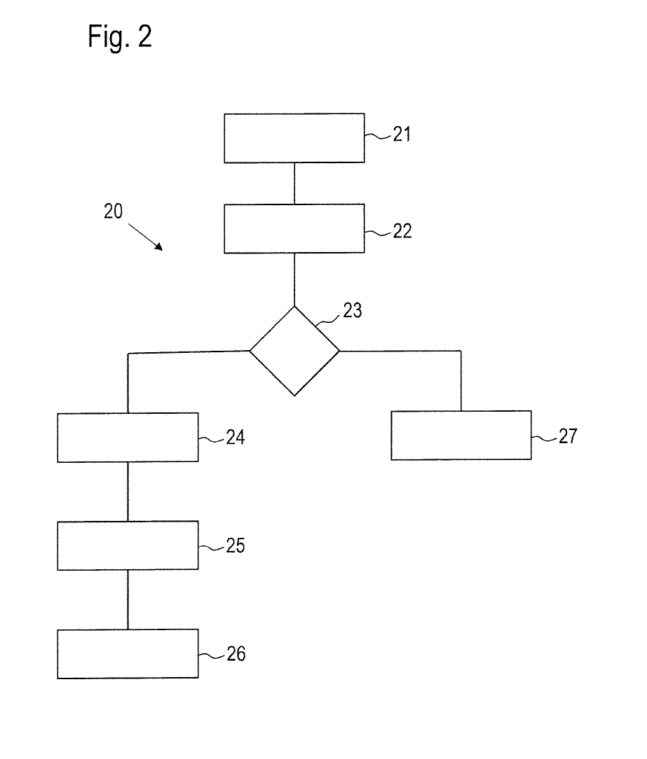

FIG. 2 shows a flowchart 20. In step 21, a data network connection is established. The computer systems 12 and 12′ in each case log into the internal network of the secured environment 10 and thereby establish the data network connection through the data network interface 13. In an alternative example, the computer systems 12 and/or 12′ establish a data network, to which other computer systems such as the server 11 can log in to establish the data network connection.

Once the data network connection has been established, the computer system 12 or 12′ searches files provided by the server 11 in step 22. In the example, the computer system 12 or 12′ searches update files to keep the computer system 12 or 12′ up-to-date. In particular, the computer system 12 or 12′ searches a file or a file package with a predetermined name of the at least one predetermined file 14 on all servers connected to the computer system 12 or 12′. If a file or a file package having the predetermined name is found, e.g. a “set_to_manufacturing_mode” package, a signature 15 of the found at least one predetermined file 14 is verified in step 23.

In step 23, the signature 15 of the at least one predetermined file 14 is verified. In the example, a checksum (hash value) of the signature 15 is verified by the computer system 12 or 12′. Thus, it is ensured that the at least one predetermined file 14 originates from a legitimatized source. If the verification of the signature 15 is successful, the at least one predetermined file 14 is downloaded in step 24.

In step 25, the downloaded, at least one predetermined file 14 is executed. For example, upon execution of the at least one predetermined file 14, a program is started, which can access a system file of the computer system 12 or 12′. Here, the system file is renamed. In the example, a boot file required to start the computer system is modified. This is a security-critical action. By the previous authentication of the at least one predetermined file 14 in the network in the secured environment 10, it is ensured that this is not malware.

Now, in step 26, a security-relevant application is executed on the computer system 12, 12′. In the example, the security-relevant application is a complete system reflash. Alternatively, the further individual firmware or software files of the computer system 12 or 12′ can be accessed and altered. Thus, maintenance of the computer system 12 or 12′ can be carried out in a secure and quick manner. The computer system 12 or 12′ can be restored to its original factory settings, for example.

If the verification of the signature 15 in step 23 showed that the signature 15 is not trustworthy, the predetermined file 14 is not downloaded. In another configuration, it is additionally possible to disconnect the data network connection to the data network.

In another example, while establishing the data network connection in step 21, additionally a verification of the data network and/or of the server 11 in the data network is performed. Here, a MAC address of the server 11 is verified. In further examples, further or alternative verifications are performed such as the verification of a server certificate or a network name.

If irregularities or an indication of manipulation occurs in this verification, the data network connection is not established, or disconnected, respectively. Thus, the computer system 12 or 12′ is protected against access.

In another example, in step 25, the at least one predetermined file 14 is installed on the computer system 12 or 12′. During installation, the at least one predetermined file 14 is modified, in particular renamed.

In another example, in addition, the computer systems 12, 12′, 12″ are maintenance-free computer systems. In such computer systems, defects can usually not be repaired. Such computer systems 12, 12′, 12″ can be restored by the above-described method. If the computer systems according to the example shown in FIG. 1 are maintenance-free, the computer systems 12 and 12′ can be restored in the secured environment 10.

1-10. (canceled)

11. A method of executing a security-relevant application on a computer system in a secured environment comprising:
establishing a data network connection via an internal network of the secured environment between the computer system and a server arranged in the secured environment;
searching, by the computer system, for at least one predetermined file on the server after the data network connection has been established;
verifying, by the computer system, a signature of the at least one predetermined file, if the at least one predetermined file has been found;
executing, by the computer system, the at least one predetermined file if the verification of the signature was successful, wherein a system file is modified through the execution of the at least one predetermined file; and
starting the security-relevant application after the at least one predetermined file has been successfully executed.

12. The method according to claim 11, wherein executing the at least one predetermined file includes a renaming of the system file.

13. The method according to claim 11, wherein the at least one predetermined file is part of a file package, and the file package is searched for, verified, and executed.

14. The method according to claim 11, wherein a flash memory of the computer system is programmed upon execution of the security-relevant application.

15. The method according to claim 11, wherein a recovery mode is called up upon execution of the security-relevant application.

16. A computer system with a data network interface, wherein the computer system is configured to establish in a secured environment a data network connection to a server via an internal network via the data network interface, which server is arranged in the secured environment, and to search at least one predetermined file on the server after the data network connection has been established, and to verify a signature of the at least one predetermined file when the at least one predetermined file has been found on the server, and to execute the at least one predetermined file, and subsequently, to start a security-relevant application, wherein a system file is modified upon execution of the at least one predetermined file.

17. An arrangement comprising a computer system and a server, wherein the server is arranged in a secured environment with an internal network, and provides at least one predetermined file for the computer system, wherein the computer system is configured to search for the at least one predetermined file on the server, and, after finding the at least one predetermined file, to verify a signature of the at least one predetermined file, and, after successful verification of the signature, to execute the at least one predetermined file and, subsequently, to start a security-relevant application.

18. The arrangement according to claim 17, wherein the server and the computer system are connected to an internal network of a maintenance center or service center.

19. The arrangement according to claim 17, wherein the security-relevant application is configured to program a flash memory of the computer system.

20. The arrangement according to claim 17, wherein the security-relevant application is configured to call up a recovery mode.

21. The method according to claim 12, wherein a flash memory of the computer system is programmed upon execution of the security-relevant application.

22. The method according to claim 14, wherein a recovery mode is called up upon execution of the security-relevant application.

23. The arrangement according to claim 19, wherein the security-relevant application is configured to call up a recovery mode.
